(19) United States
(12) Patent Application Publication
(10) Pub. No.: US 2025/0323901 A1
(43) Pub. Date: Oct. 16, 2025

(54) END-TO-END ENCRYPTED TRANSMISSIONS IN A WIRELESS MESH NETWORK

(71) Applicant: QUALCOMM Incorporated, San Diego, CA (US)

(72) Inventors: Sai Yiu Duncan HO, San Diego, CA (US); George CHERIAN, San Diego, CA (US); Abhishek Pramod PATIL, San Diego, CA (US); Alfred ASTERJADHI, San Diego, CA (US); Gaurang NAIK, San Diego, CA (US); Giovanni CHISCI, San Diego, CA (US); Sanket Sanjay KALAMKAR, San Diego, CA (US); Sherief HELWA, San Diego, CA (US)

(21) Appl. No.: 18/633,189

(22) Filed: Apr. 11, 2024

(51) Int. Cl. H04L 9/40; H04W 12/03; H04W 84/12

(52) U.S. Cl. CPC H04L 63/0485; H04W 12/03; H04W 84/12

(57) ABSTRACT

This disclosure provides methods, components, devices and systems for end-to-end encrypted transmissions in a wireless mesh network. Some aspects more specifically relate to communications between one or more access points (APs) and one or more stations (STAs) in a wireless mesh network. In some examples, the wireless mesh network may include a central AP (CAP) that communicates with one or more other APs via one or more links. In the wireless mesh network, user data may be transmitted to a STA via data packets that are encrypted per link. In some implementations, the data packets may be end-to-end encrypted between the CAP and the STA and assigned end-to-end packet numbers and end-to-end sequence number. Thus, a first data packet may be encapsulated within one or more second data packets such that one or more intermediate APs may refrain from decrypting the first data packet.

### TECHNICAL FIELD

This disclosure relates generally to wireless communication and, more specifically, to end-to-end encrypted transmissions in a wireless mesh network between a central access point (AP) and a STA.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some WLANs, APs and STAs may communicate in a mesh network that includes one or more APs connected to each other to provide service to one or more STAs. In such a mesh network, a central AP may be connected to a wireless area network, and one or more satellite APs may be connected to the central AP to provide extended coverage to one or STAs.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point (AP) is described. The method may include generating a first data packet for a first station (STA) at the first access point, where the first access point is designated as a central AP for the first STA within a wireless mesh network and transmitting the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

One innovative aspect of the subject matter described in this disclosure can be implemented in a first AP for wireless communications is described. The first AP may include a processing system that includes processor circuitry and memory circuitry that stores code. The processing system may be configured to cause the first AP to generate a first data packet for a first STA at the first access point, where the first access point is designated as a central AP for the first STA within a wireless mesh network and transmit the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

Another innovative aspect of the subject matter described in this disclosure can be implemented in a first AP for wireless communications is described. The first AP may include means for generating a first data packet for a first STA at the first access point, where the first access point is designated as a central AP for the first STA within a wireless mesh network and means for transmitting the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

One innovative aspect of the subject matter described in this disclosure can be implemented in a non-transitory computer-readable medium storing code for wireless communications is described. The code may include instructions executable by one or more processors to generate a first data packet for a first STA at the first access point, where the first access point is designated as a central AP for the first STA within a wireless mesh network and transmit the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

Some implementations of the method, first APs, and non-transitory computer-readable medium described herein may further include operations, features, means, or instructions for assigning the first data packet an end-to-end packet number, where the first data packet that may be encapsulated within the one or more second data packets includes the end-to-end packet number.

Some implementations of the method, first APs, and non-transitory computer-readable medium described herein may further include operations, features, means, or instructions for assigning a medium access control (MAC) service data unit (MSDU) associated with the first data packet an end-to-end sequence number, where the MSDU associated with the first data packet that may be encapsulated within the one or more second data packets includes the end-to-end sequence number.

Some implementations of the method, first APs, and non-transitory computer-readable medium described herein may further include operations, features, means, or instructions for generating a third data packet for a second STA at the first access point, the one or more second data packets including at least one aggregated MAC protocol data unit (A-MPDU) including both the first data packet and the third data packet.

One innovative aspect of the subject matter described in this disclosure can be implemented in a method for wireless communications by a first STA is described. The method may include connecting to a first AP via two or more links associated with two or more second APs of a wireless mesh network, where the first AP is designated as a central AP for the first STA within the wireless mesh network and receiving a first data packet from the first AP via the two or more links of the wireless mesh network such that the first data packet is end-to-end encrypted between the first AP and the first STA and the first data packet is encapsulated within one or more second data packets associated with individual links of the wireless mesh network.

One innovative aspect of the subject matter described in this disclosure can be implemented in a first STA for wireless communications is described. The first STA may include a processing system that includes processor circuitry and memory circuitry that stores code. The processing system may be configured to cause the first STA to connect to a first AP via two or more links associated with two or more second APs of a wireless mesh network, where the first AP is designated as a central AP for the first STA within the wireless mesh network and receive a first data packet from the first AP via the two or more links of the wireless mesh network such that the first data packet is end-to-end encrypted between the first AP and the first STA and the first data packet is encapsulated within one or more second data packets associated with individual links of the wireless mesh network.

Another innovative aspect of the subject matter described in this disclosure can be implemented in a first STA for wireless communications is described. The first STA may include means for connecting to a first AP via two or more links associated with two or more second APs of a wireless mesh network, where the first AP is designated as a central AP for the first STA within the wireless mesh network and means for receiving a first data packet from the first AP via the two or more links of the wireless mesh network such that the first data packet is end-to-end encrypted between the first AP and the first STA and the first data packet is encapsulated within one or more second data packets associated with individual links of the wireless mesh network.

One innovative aspect of the subject matter described in this disclosure can be implemented in a non-transitory computer-readable medium storing code for wireless communications is described. The code may include instructions executable by one or more processors to connect to a first AP via two or more links associated with two or more second APs of a wireless mesh network, where the first AP is designated as a central AP for the first STA within the wireless mesh network and receive a first data packet from the first AP via the two or more links of the wireless mesh network such that the first data packet is end-to-end encrypted between the first AP and the first STA and the first data packet is encapsulated within one or more second data packets associated with individual links of the wireless mesh network.

In some implementations of the method, first STAs, and non-transitory computer-readable medium described herein, the one or more second data packets associated with the individual links of the wireless mesh network include a header that includes decryption information associated with the first data packet.

Some implementations of the method, first STAs, and non-transitory computer-readable medium described herein may further include operations, features, means, or instructions for receiving the first data packet from the first AP includes a MSDU associated with the first data packet being end-to-end encrypted between the first AP and the first STA at a MAC service AP (MAC-SAP) of the first AP.

In some implementations of the method, first STAs, and non-transitory computer-readable medium described herein, the MSDU associated with the first data packet may be assigned an end-to-end packet number, an end-to-end sequence number, or both.

In some implementations of the method, first STAs, and non-transitory computer-readable medium described herein, the first data packet may be encapsulated within a data portion of the one or more second packets associated with the individual links of the wireless mesh network.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example protocol data unit (PDU) usable for communications between a wireless access point (AP) and one or more wireless stations (STAs).

FIG. 4 shows an example of a signaling diagram that supports end-to-end encrypted transmissions in a wireless mesh network.

FIG. 5 shows an example of an encrypted data packet that supports end-to-end encrypted transmissions in a wireless mesh network.

FIG. 6 shows an example of a process flow that supports end-to-end encrypted transmissions in a wireless mesh network.

FIG. 7 shows a block diagram of an example wireless communication device that supports end-to-end encrypted transmissions in a wireless mesh network.

FIG. 8 shows a block diagram of an example wireless communication device that supports end-to-end encrypted transmissions in a wireless mesh network.

FIG. 9 shows a flowchart illustrating an example process performable by or at a first access point (AP) that supports end-to-end encrypted transmissions in a wireless mesh network.

FIG. 10 shows a flowchart illustrating an example process performable by or at a first station (STA) that supports end-to-end encrypted transmissions in a wireless mesh network.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to communications between one or more access points (APs) and one or more stations (STAs). Some aspects more specifically relate to communications between the one or more APs and the one or more STAs in a wireless mesh network. In some examples, the wireless mesh network may be an example of a multi-AP mesh network that includes a root or central AP (CAP) that is connected to a wide area network (WAN). The CAP may communicate with one or more other APs via one or more links. In some implementations, a link in the wireless mesh network may be a wireless backhaul link between a STA and AP pair or a non-AP multi-link device (MLD) and an AP MLD pair. In some other implementations, a link in the wireless mesh network may be a wired backhaul link between a STA and AP pair or non-AP MLD and AP MLD pair. In the wireless mesh network, user data may be transmitted via data packets (such as local area network (LAN) packets) and the data packets may be encrypted per hop (such as per each wireless backhaul link traveled). Further, if a STA roams within the wireless mesh network, the STA may connect to different APs and thus a data packet may be transmitted to multiple APs before reaching the STA.

The techniques of the present disclosure enable a STA to seamlessly roam within a wireless mesh network by leveraging end-to-end encryption of data packets between the CAP and the STA. In some implementations, a single mobility domain (SMD) AP MLD may remain at the CAP and the data packets may be end-to-end encrypted by assigning end-to-end packet numbers to the data packets. In some other implementations, the CAP may assign end-to-end sequence numbers to the data packets to enable the STA to be connected to multiple AP MLDs at a given time. Further, a first data packet may be encrypted within one or more second data packets that are associated with the individual links such that it may be unnecessary for the respective intermediate APs between the CAP and the STA to decrypt the first data packet.

Particular aspects of the subject matter described in this disclosure can be implemented to realize one or more of the following potential advantages. In some examples, enabling end-to-end encryption of data packets between the CAP and the STA may reduce communication latency while the STA is roaming. For example, as the STA roams within the mesh network and data packets are transmitted to the STA via two or more links associated with two or more intermediate APs, the respective intermediate APs may refrain from decrypting and re-encrypting the data packet. Moreover, in accordance with the techniques of the present disclosure, once a data packet is end-to-end encrypted, APs may be capable of transmitting data packets via backhaul connections while refraining from implementing any additional security or encryption. For example, data packets transmitted via Ethernet links may be relatively safe due to the end-to-end encryption, even though the Ethernet link may be incapable of providing encryption. Additionally, or alternatively, once a data packet is end-to-end encrypted, wireless devices may be capable of duplicating the data packet and transmitting the data packet(s) to multiple non-collocated AP MLDs for transmission to the same non-AP MLD using joint transmissions (such as for over-the-air packets from two transmitters that are identical bitwise). Moreover, such techniques of the present disclosure may be relatively more efficient compared to per-AP local encryptions which may produce different bits from different AP MLDs and would be incapable of being combined using joint transmission techniques. Therefore, the APs may be capable of forwarding the data packets to the STA relatively faster and more efficiently, thus increasing reliability and user experience while improving power consumption and spectral efficiency.

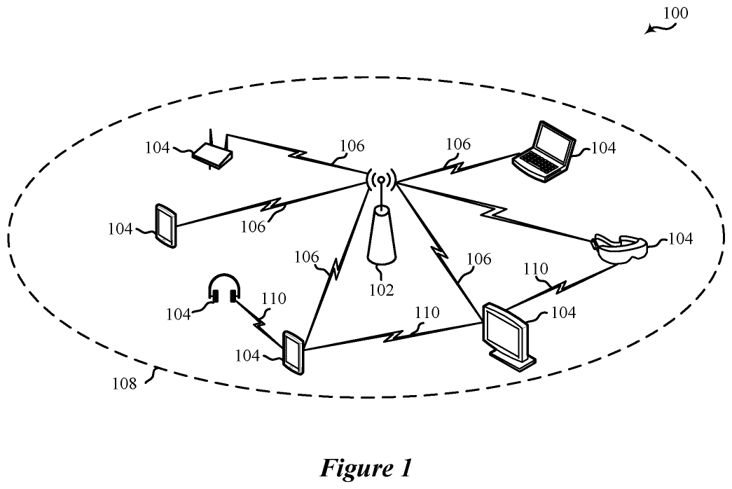

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHz-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some implementations of the wireless communication network 100, the wireless communication network 100 may be an example of a wireless mesh network that includes a root AP 102 or CAP that is connected to a WAN. In some implementations, user data packets transmitted to a STA 104 may be end-to-end encrypted between a CAP (such as an AP 102) and the STA 104 to enable the STAs 104 to seamlessly roam the wireless communication network 100 and connect to various different APs 102. In some examples, to allow the STAs 104 the capability of correctly receiving the end-to-end encrypted data packets the CAP may assign an end-to-end PN, an end-to-end sequency number, or both to the data packets. Further, the data packet may be encapsulated with one or more other data packets associated with the individual links of the wireless mesh network such that the data packet may remain end-to-end encrypted. Therefore, as described elsewhere herein, one or more intermediate APs 102 of the wireless communication network 100 may receive a first data packet and may refrain from decrypting the first data packet before encapsulating the first data packet within one or more second data packets. Thus, the wireless communication network 100 may provide an end-to-end encryption between a CAP and a STA 104 to enable STAs 104 to roam within the wireless communication network 100.

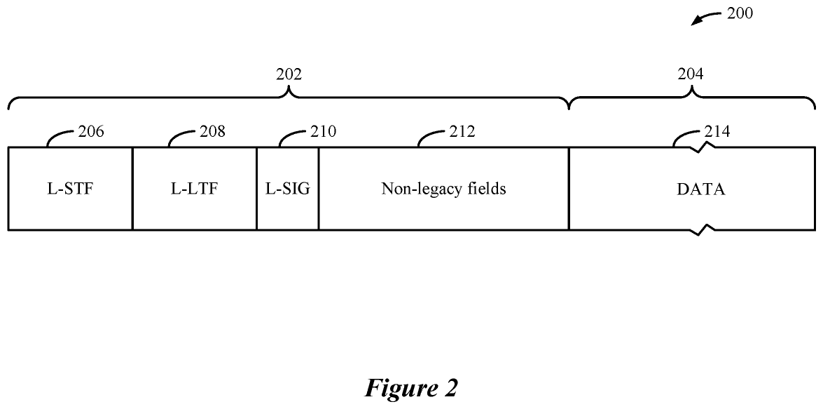

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

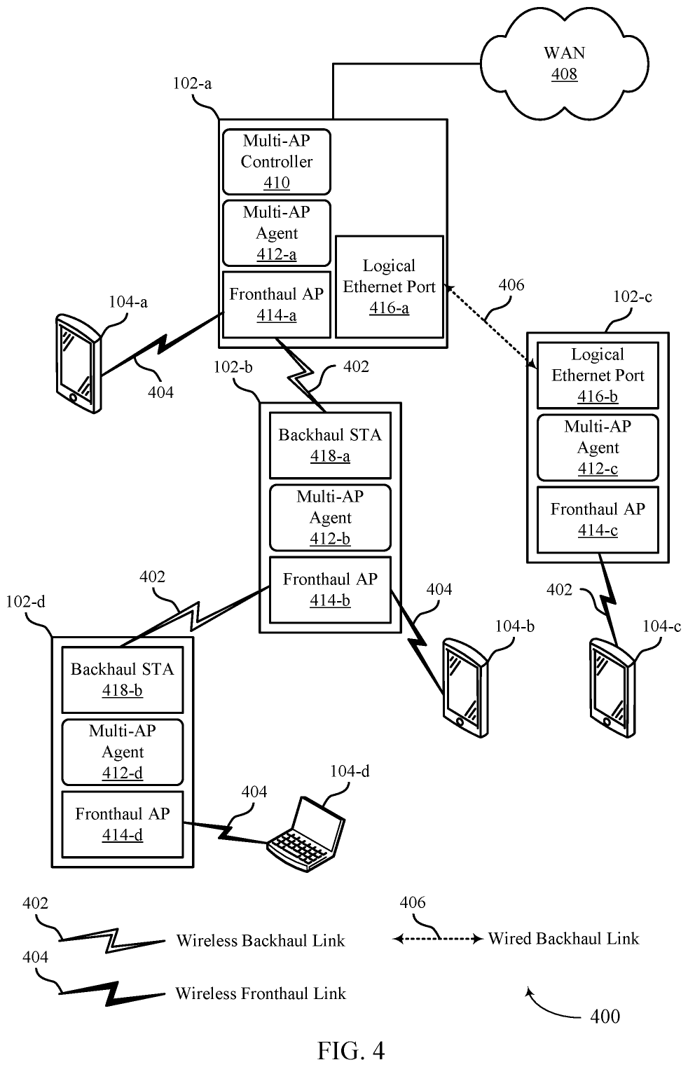

In some implementations, a STA may receive a PDU 200 that is end-to-end encrypted between an AP and the STA. For example, in accordance with the techniques of the present disclosure, the STA may receive the PDU 200 that includes a separate PDU encapsulated within the data field 214 of the PDU 200 where the separate PDU is associated with an end-to-end encryption packet number and end-to-end encryption sequency number. By encapsulating a first PDU 200 within the data field 214 of one or more second PDUs 200, first PDU 200 may be secured without requiring intermediate satellite APs to separately decrypt and encrypt the first PDU 200 when forwarding the first PDU 200 through the mesh network. Further details of the encapsulation of a first PDU within the data field 214 of one or more second PDUs 200 are described with reference to FIGS. 4-6.

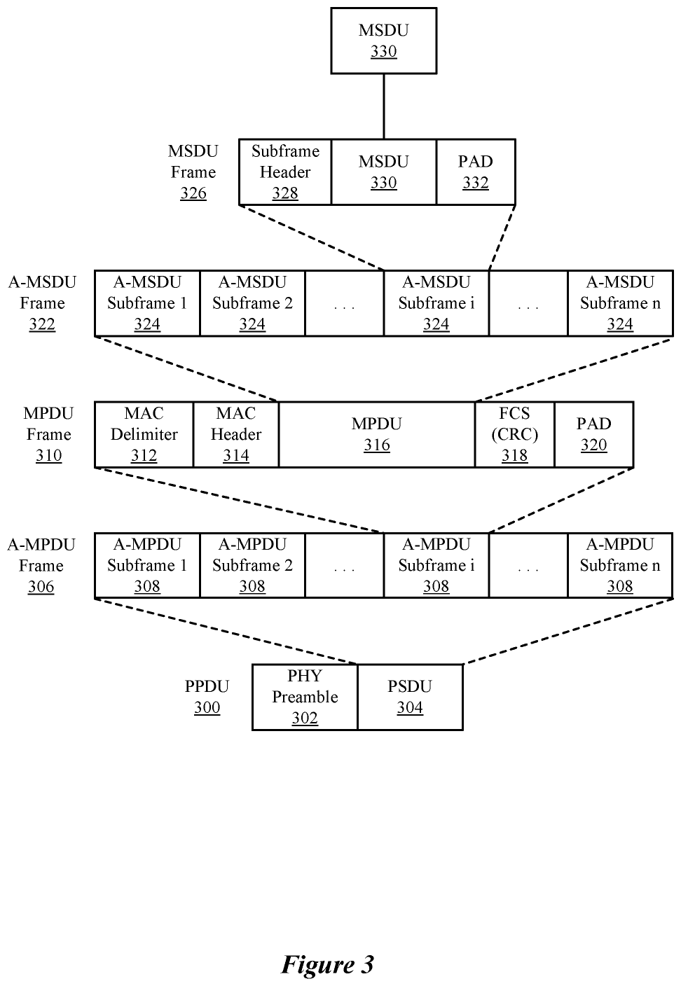

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (cMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the cMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHZ band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some implementations, a STA may receive a MSDU 330 that is end-to-end encrypted between an AP and the STA. For example, in accordance with the techniques of the present disclosure, the STA may receive the MSDU 330 that includes a separate MSDU 330 encapsulated within the data field of the MSDU 330 where the separate MSDU 330 is associated with an end-to-end encryption packet number and end-to-end encryption sequency number. By encapsulating a first MSDU 330 within the data field of one or more second MSDU 330, two or more APs may be capable of refraining from decrypting the first MSDU 330 to allow the first PDU to be encrypted between a root AP or CAP and a STA. Further descriptions of the encapsulation of a first MSDU 330 within the data field of one or more second MSDU 330 may be described elsewhere herein, such as with reference to FIGS. 4-6.

FIG. 4 shows an example of a wireless mesh network 400 that supports end-to-end encrypted transmissions in a wireless mesh network. The wireless mesh network 400 may implement or be implemented to realize one or more aspects of the wireless communication network 100. For example, the wireless mesh network 400 illustrates communications between one or more APs 102 (such as an AP 102-a, an AP 102-b, an AP 102-c, and an AP 102-d) and one or more STAs 104 (such as a STA 104-a, a STA 104-b, a STA 104-c, and a STA 104-d) which may be examples of an AP 102 and a STA 104 as illustrated by and described with reference to FIG. 1. In some implementations, the one or more APs 102 and the one or more STAs 104 may communicate via one or more wireless backhaul links 402, one or more wireless fronthaul links 404, and a wired backhaul link 406. Moreover, one or more wireless backhaul links 402, the one or more wireless fronthaul links 404, and the wired backhaul link 406 may be examples of a communication link 106 as illustrated by and described with reference to FIG. 1.

In some implementations, the wireless mesh network 400 may have one centralized AP 102 or CAP (such as the AP 102-a) that has access to a WAN 408, such as a wired local area network or the Internet. Moreover, the wireless mesh network 400 also may include one or more satellite APs 102 to provide extended coverage to the one or more APs 102 and the one or more STAs 104 of the wireless mesh network 400. For example, a satellite AP 102 may connect to the AP 102-a (such as the CAP), either directly or via one or more other satellite APs 102, to access the backhaul via Wi-Fi or Ethernet. Moreover, in some implementations, as the AP 102-a may be the CAP of the wireless mesh network 400 the AP 102-a may include a multi-AP controller 410. In some examples, the multi-AP controller 410 may enable the AP 102-a to coordinate communications between the one or more APs 102 of the wireless mesh network 400.

Further, the AP 102-a and each other AP 102 of the wireless mesh network 400 (such as the AP 102-b, the AP 102-c, and the AP 102-d) may be configured with a multi-AP agent 412 (such as a multi-AP agent 412-a of the AP 102-a, a multi-AP agent 412-b of the AP 102-b, a multi-AP agent 412-c of the AP 102-c, and a multi-AP agent 412-d of the AP 102-d). The multi-AP agents 412 may be used for a respective AP 102 to connect to the multi-AP controller 410 of the AP 102-a which has access to the WAN 408. Therefore, each AP 102 of the wireless mesh network 400 may connect to the AP 102-a to receive access to the WAN 408. In some examples, the wireless mesh network 400 may be an example of an EasyMesh Wi-Fi network (Wi-Fi EasyMesh™). Further, in some implementations, for an AP 102 to connect a respective multi-AP agent 412 to the multi-AP controller 410 of the AP 102-a, the multi-AP controller 410 may be associated with a unique identifier (ID). For example, the AP 102-b may be capable of connecting to the AP 102-a and thus the WAN 408 by being configured with the ID of the multi-AP controller 410 of the AP 102-a such that the multi-AP agent 412-b is capable of connecting to the multi-AP controller 410 to establish the connection between the AP 102-b and the AP 102-a.

In some implementations, the connections between APs 102 may be wireless backhaul links 402 and each respective wireless backhaul link 402 may be a STA 104 to AP 102 pair or a non-AP MLD to AP 102 MLD pair. For example, a connection between the AP 102-a and the AP 102-b may be via a wireless backhaul link 402 between a fronthaul AP 414-a and a backhaul STA 418-a (a STA 104 to AP 102 pair). When connecting with the AP 102-a, the AP 102-b may act as a STA 104 by connecting with the AP 102-a from the backhaul STA 418-a via the wireless backhaul link 402. In some other implementations, the AP 102-a may connect to an AP 102 from a logical ethernet port 416-a via a wired backhaul link. For example, the AP 102-c may connect to the AP 102-a via the wired backhaul link 406 such that the logical ethernet port 416-a of the AP 102-a connects to the logical ethernet port 416-b of the AP 102-c via the wired backhaul link 406. Thus, the AP 102-c may access the WAN 408 that the AP 102-a is connected to via the wired backhaul link 406 between the logical ethernet port 416-a of the AP 102-a and the logical ethernet port 416-b of the AP 102-c. Additionally, or alternatively, the respective APs 102 may connect to non-AP STAs 104 (such as the STA 104-a, the STA 104-b, the STA 104-c, and the STA 104-c) from fronthaul APs 414 (such as the fronthaul AP 414-a, a fronthaul AP 414-b, a fronthaul AP 414-c, and a fronthaul AP 414-d) via the one or more wireless fronthaul links 404. For example, the fronthaul AP 414-a of the AP 102-a may connect to the STA 104-a via a wireless fronthaul link 404, the fronthaul AP 414-b of the AP 102-b may connect to the STA 104-b via a wireless fronthaul link 404, the fronthaul AP 414-c of the AP 102-c may connect to the STA 104-c via wireless fronthaul link 404, and the fronthaul AP 414-d of the AP 102-d may connect to the STA 104-d via a wireless fronthaul link 404.

Using the one or more wireless backhaul links 402 or 404, the wired backhaul link 406, or both, user data may be transmitted as LAN packets within the backhaul. In some implementations, when transmitted over the wired backhaul link 406 via an Ethernet backhaul, the LAN packets may be unencrypted. In some other implementations, when transmitted over Wi-Fi backhaul (such as via the one or more wireless backhaul links 402) the LAN packets may be encrypted per hop. For example, if the STA 104-d transmits an uplink packet, the uplink packet may traverse from the STA 104-d to the fronthaul AP 414-d of the AP 102-d via a wireless fronthaul link 404, from a backhaul STA 418-b of the AP 102-d to the fronthaul AP 414-b of the AP 102-b via a wireless backhaul link 402, and from the backhaul STA 418-a of the AP 102-b to the fronthaul AP 414-a of the AP 102-a via a wireless backhaul link.

Thus, the uplink packet may be transmitted to two separate APs 102 before reaching the AP 102-a. In some implementations, each AP 102 that receives the uplink packet may decrypt the uplink packet and re-encrypt the uplink packet before transmitting (before the next hop). Therefore, in some examples, the data of the uplink packet may be accessible to more than an intended receiver. Moreover, decrypting and re-encrypting the uplink packet at each hop may be relatively time consuming and may result in an increase in delay for communications within the wireless mesh network 400. Further, if the 300 is configured with a relatively large quantity of intermediate APs 102, the latency associated with STAs 104 transmitting and receiving packets from may increase accordingly.

In another implementation, if the STA 104-c transmits an encrypted uplink data packet to the AP 102-a, the uplink packet may traverse from the STA 104-c to the fronthaul AP 414-c of the AP 102-c via a wireless fronthaul link 404 where the AP 102-c may decrypt the uplink packet. However, as the AP 102-c may transmit the uplink packet to the AP 102-a from the logical ethernet port 416-b to the logical ethernet port 416-a via the wired backhaul link 406, the AP 102-c may refrain from re-encrypting the uplink packet before transmitting the uplink packet via the Ethernet backhaul of the wired backhaul link 406. Thus, the transmission of the uplink packet may be insecure which can result in a breach of security if a fraudulent user intercepts the unencrypted uplink packet. Therefore, if a STA 104 roams through the wireless mesh network 400, the efficiency and security of transmitting data packets to the AP 102-a and receiving data packets from the AP 102-a may be relatively unreliable and unpredictable.

To improve the efficiency and security of the wireless mesh network 400, the techniques of the present disclosure may describe enabling a STA 104 being capable of seamlessly roam within the wireless mesh network 400. For example, in some implementations, the wireless backhaul links 402 may act as encrypted tunnels for forwarding the data packets (such as the LAN packets) between the CAP (such as the AP 102-a) and an end client (such as a STA 104). Further, in some cases, each AP 102 of the wireless mesh network 400 may be an AP 102 MLD and as a respective STA 104 roams the wireless mesh network 400, an SMD AP 102 MLD may follow the STAs 104 such that the AP 102 connected to the STAs 104 is associated with the SMD AP 102 MLD. In some examples, an SMD AP 102 MLD may control one or more surrounding APs 102 such that when a STA 104 connects to a respective AP 102, the STA 104 may associate with the SMD AP 102 MLD rather than being associated with the AP 102 to which the STA 104 connects.

Thus, as the STA 104 roams within the wireless mesh network 400, the STA 104 may be capable of remaining associated with the SMD AP 102 MLD and the wireless mesh network 400 as a whole. Further, the STA 104 may be refrain from reassociating with the network each time the STA 104 connects to an additional AP 102. Therefore, in some implementations of the present disclosure, the SMD AP 102 MLD may move with the STA 104 such that the AP 102 the STA 104 is connected to is also associated with the SMD AP 102 MLD. In some implementations, the encryption and decryption of user packets may be performed by a service AP 102 and a client (such as a STA 104). In some examples, the data path switching also may remain such that the CAP (the AP 102-a) forwards downlink data packets to a single AP 102 at a time. However, in such implementations, while the STA 104 may experience a decrease in connection delays while roaming due to the SMD AP 102 MLD moving along with the STA 104, each hop may be expected to perform decryption and re-encryption of data packets, thus resulting in a level of latency in communications. Moreover, such implementations of the SMD AP 102 MLD following a roaming STA 104 may be unable to support joint transmission techniques using concurrent non-collocated links for the same client (STA 104). For example, as the SMD AP 102 MLD may move to be associated with the AP 102 directly connected to a roaming STA 104, the STA 104 may be unable to be served by multiple SMD AP 102 MLDs.

In some other implementations, to support joint transmissions, the SMD AP 102 MLD may be anchored or placed at the CAP (the AP 102-a) of the wireless mesh network 400. By anchoring the SMD AP 102 MLD, in accordance with the techniques of the present disclosure, the wireless mesh network 400 may ensure that the data packets are end-to-end encrypted between the CAP and a client (such as a STA 104), regardless of a quantity of hops between the CAP and the client. To enable the end-to-end encryption, the AP 102-a may assign an end-to-end packet number to a respective data packet and perform encryption on the data packet. The AP 102-a may then transmit the data packet in-order to the next hop to reach a respective STA 104 and may rely on the hops to deliver the data packet reliably and in order. However, in some cases, a client (such as a STA 104) may see sequency number gaps due to packet loss between hops. In some implementations, downlink data packets for different clients also may be multiplexed into a single A-MPDU to reduce the transmission overhead. Therefore, in accordance with the techniques of the present disclosure, each hop from a respective fronthaul AP 414 to a backhaul STA 418 may use a sequency number space or BA that is unique to the hop for transmitting the MPDU and may refrain from decrypting and re-encrypting the user data packet. The data packet generated by a respective hop may be encrypted by the respective hop and may encapsulate the data packet that includes the user data within the data field or payload of a data packet and carry information related to the end-to-end decryption within a Galois/counter mode protection (GCMP) header of the data packet. Moreover, the end-to-end decryption information in the GCMP header may be solely used by the end points of a communication (such as a CAP or client) to decrypt the user data of the data packet.

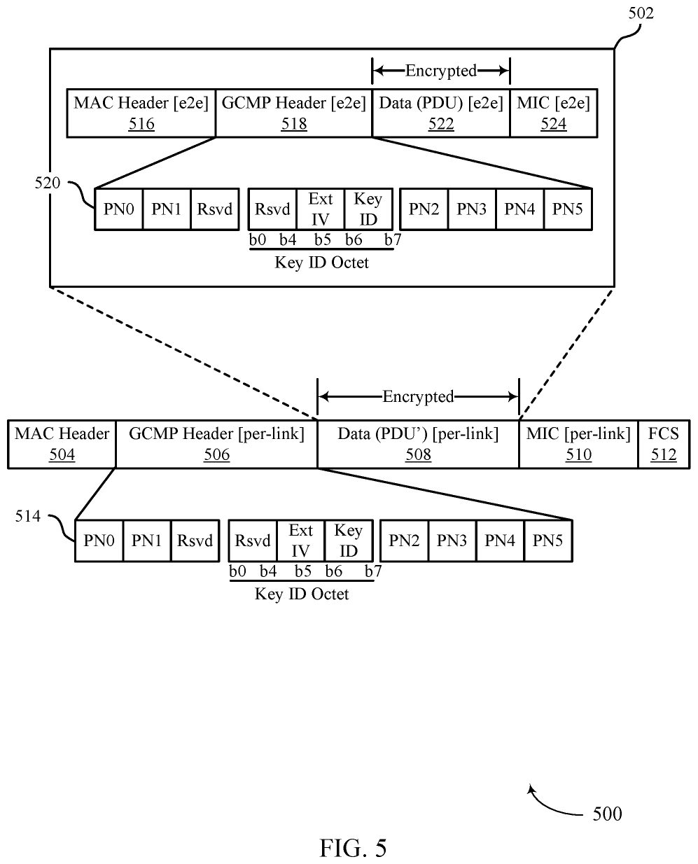

Therefore, the user data may remain encrypted from one end point to the other (such as from the AP 102-a to a respective STA or vice versa) thus resulting in improved security and reliability. Additionally, or alternatively, the wireless mesh network 400 may experience a decrease in latency due to a lack of decryption and re-encryption on each hop and a lack of context transfer between hops. Moreover, such techniques of the present disclosure may be relatively low in cost based on using network architectures that are in place. However, by removing the decryption and re-encryption via each hop, the encryption and decryption load at the AP 102-a (the CAP) may be relatively high, thus resulting in some in latency at the AP 102-a. For example, to support multiple clients (STAs 104) within the wireless mesh network 400, the AP 102-a may be expected to encrypt the user data for each client separately and thus also may decrypt respective user data from the client separately. Moreover, in some examples, the wireless mesh network 400 may be unable to rely on wireless distribution system (WDS) 4-address data frames between the hops. For example, a client may be unaware of if the end-to-end encrypted data is user data of MLD-level management information due to a lack of MAC header being caried in the WDS 4-address data frames. Further descriptions of the techniques of the present disclosure that enables a full PDU with a MAC header to be encrypted and encapsulated with a data field of a PDU may be described elsewhere herein, such as with reference to FIG. 5.

In such implementations described herein, a respective STA 104 may be incapable of being served by more than one AP 102 MLD at a time. For example, since the AP 102-a may refrain from assigning a sequency number to the end-to-end encrypted packets, a respective STA 104 receiving the data packets bay be unable to reorder the data packets. In some examples, as a STA 104 may be roaming within the wireless mesh network 400 the STA 104 also may receive data packets out of order based on the data packets being received via different data paths. Thus, due to the lack of sequency number, the AP 102-a may transmit duplicates of an MSDU via different non-collocated links to increase the reliability of a STA 104 receiving each data packet and receiving each data packet in order. In some examples, such duplicate transmissions may be coordinated multi-point (COMP) transmissions from multiple non-collocated links.

In another implementation, to support a client being capable of being served by two or more AP 102 MLDs at a time, the AP 102-a also may add an end-to-end encryption SN (such as a SN_e2e) for each MSDU belonging to a respective flow upon entering the first MAC service AP (SAP). In some implementations, the MSDU may be end-to-end encrypted at the entry MAC-SAP and the encryption/decryption information, and the flow information may be included with the encrypted MSDU such that the whole MSDU can be represented by an encapsulated MSDU (an MSDU′). Thus, the intermediate APs 102 (such as the AP 102-b, the AP 102-c, and the AP 102-c) may encapsulate a first MSDU from the AP 102-a within a data field of a second MSDU. For example, a data packet being transmitted from the AP 102-a to the STA 104-d may be encapsulated in a data packet between the AP 102-b and the AP 102-d and a data packet between the AP 102-d and the STA 104-d. Additionally, or alternatively, data packets also may be encrypted when transmitted on the Ethernet backhaul (such as via the wired backhaul link 406).

However, since an internet protocol (IP) header portion may be encrypted, the intermediate APs 102 may be incapable of performing operations that use information from the IP layer which can result in a decrease in a per-node (per-AP) quality of service. In some implementations, to prevent such quality of service decreases, the AP 102-a may duplicate the relevant IP information outside the encrypted portion of the MSDU and can include quality of service related information as unencrypted information (such as a stream classification service ID (SCSID) that the packet belongs to of the flow information). In some other implementations, to prevent a decrease in the quality of service. the AP 102-a may perform some traffic classification of the packet which may be performed by the AP 102-a and can be reused per-hop. In another implementation, the AP 102-a may refrain from encrypting the MSDU and the MSDU may be encrypted per-hop. Thus, the intermediate APs 102 may be capable of performing IP layer operations as the IP layer may remain encrypted, However, data packets transmitted via the Ethernet backhaul (such as via the wired backhaul link 406) may be unencrypted or protected.

Thus, in accordance with the techniques of the present disclosure, the wireless mesh network 400 may be capable of enhancing the roaming capabilities of STAs by reducing the latency associated with roaming. Further descriptions of the techniques of the present disclosure may be described elsewhere herein, such as with reference to FIG. 5. For example, FIG. 4 may illustrate the encapsulation of a first data packet within one or more second data packets to enable the end-to-end encryption.

FIG. 5 shows an example of an encrypted data packet 500 that supports end-to-end encrypted transmissions in a wireless mesh network. The encrypted data packet 500 may implement or be implemented to realize one or more aspects of the wireless communication network 100, the wireless mesh network 400, or both. For example, the encrypted data packet illustrates a PDU that is communicated between one or more APs 102 and one or more STAs 104 (which may be examples of an AP 102 and a STA 104 as illustrated by and described with reference to FIG. 1.

In some implementations, as described with reference to FIG. 4, an AP 102 that is a CAP of a wireless mesh network may perform end-to-end encryption of a data packet to generate the encrypted data packet 500 to increase the security and reliability of data transmissions. Further, the encrypted data packet 500 may result in a decrease in latency of communications as intermediate APs between the CAP and a client (such as a STA 104) may refrain from decrypting and re-encrypting the user data of a data packet. Therefore, as illustrated in FIG. 3, the encrypted data packet 500 may include an data packet 502 that includes user data for an end device that is encapsulated within the encrypted data packet 500.

In some implementations, when encapsulating the data packet 502 within the encrypted data packet 500, an AP 102 may encrypt the encrypted data packet 500 for a respective hop. For example, a first AP 102 that is a CAP of a wireless mesh network may transmit a first data packet (such as the data packet 502) to a second AP 102 that is for a first STA 104 that is connected to the second AP 102. Thus, rather than decrypting and re-encrypting the user data of the data packet 502, the second AP 102 may encapsulate the data packet 502 within a second data packet (such as the encrypted data packet 500) that is encrypted for the hop between the second AP 102 and the first STA 104. Therefore, the first STA 104 may receive the data packet 502 based on the data packet 502 being encapsulated within the encrypted data packet 500.

In some examples, the encrypted data packet 500 may include a MAC header 504, a GCMP header 506, a data field 508, a message integrity check (MIC) field 510, a frame check sequency (FCS) field 512, or any combination thereof. In some implementations, the MAC header 504 may be used to indicate the type of data within the data field 508. For example, the MAC header 504 may indicate that the data field 508 includes user data or MLD-level management data. Additionally, or alternatively, the MAC header 504 may indicate that the data field 508 includes an encapsulated data packet 502. The MAC header 504 also may be used to indicate a source and destination of the encrypted data packet 500.

The GCMP header 506 may be used to indicate one or more data items 514. For example, the GCMP header 506 may indicate a packet number of the encrypted data packet 500, an ext IV, a key ID, or any combination thereof. In some examples, the GCMP header 506 may be indicated via eight octets where the packet number is indicated via the first two and the last four octets with a reserved octet and a key ID octet included in the middle. The key ID octet may include the ext IV, the key ID, and a reserved field, that a AP 102 can use to encrypt the data of the data field 508 and the MIC field 510. Thus, the data field 508 may be encrypted based on the information of the GCMP header 506. The GCMP header 506 also may include information associated with decrypting the data field 508 such that the destination of the encrypted data packet 500 can unencrypt the encrypted data packet 500. Further, the MIC field 510 may be used for determining an authenticity of the 500. For example, a receiving device (such as a STA 104) may use the MIC field 510 to authenticate that the encrypted data packet 500 is from a respective AP 102 as indicated via the MAC header 504.

As described elsewhere herein, to enable end-to-end encryption, the data field 508 may be encrypted via information from the GCMP header 506 of the encrypted data packet 500 with an encapsulated version of the data packet 502. The data packet 502 may include a MAC header 516, a GCMP header 518 that indicates one or more data items 520, an encrypted data field 522, and a MIC field 524. Since the fields of the encrypted data packet 500 may be per-link, the encrypted data packet 500 may be encrypted for a respective AP 102 to STA 104 hop and the data packet 502 that is encapsulated within the data field 508 of the encrypted data packet 500 may be encrypted between a CAP and a receiving STA 104. For example, as illustrated withing FIG. 5, the fields of the encrypted data packet 500 may be “per-link,” and the fields of the data packet 502 may be end-to-end (“e2e” as illustrated) encrypted. Further, the data packet 502 may include an indication of a type of data and an indication of a source and destination in the MAC header 516, decryption information within the GCMP header 518, and authentication information within the MIC field 524.

Therefore, a receiving device may use such information to decrypt the user data of the encrypted data field 522. Moreover, when receiving the encrypted data packet 500, a STA 104 may first decrypt the data field 508 of the encrypted data packet 500 to receive the data packet 502 that is encrypted by the CAP and then decrypt the encrypted data field 522 of the data packet 502 to receive the user data from the source of the data packet 502. Therefore, in accordance with the techniques of the present disclosure, the user data may remain encrypted between two end devices (such as a CAP and a STA 104 client) which may result in an increase in reliability of a wireless network and a decrease in latency as the intermediate APs 102 refrain from decrypting the user data of the data packet 502. Moreover, by the techniques of the present disclosure may providing an increase in reliability and decrease in latency the techniques of the present disclosure may result in an increase in efficiency and reliability for STA 104 roaming within the wireless network Further descriptions of the techniques of the present disclosure may be described elsewhere herein, such as with reference to FIG. 5.

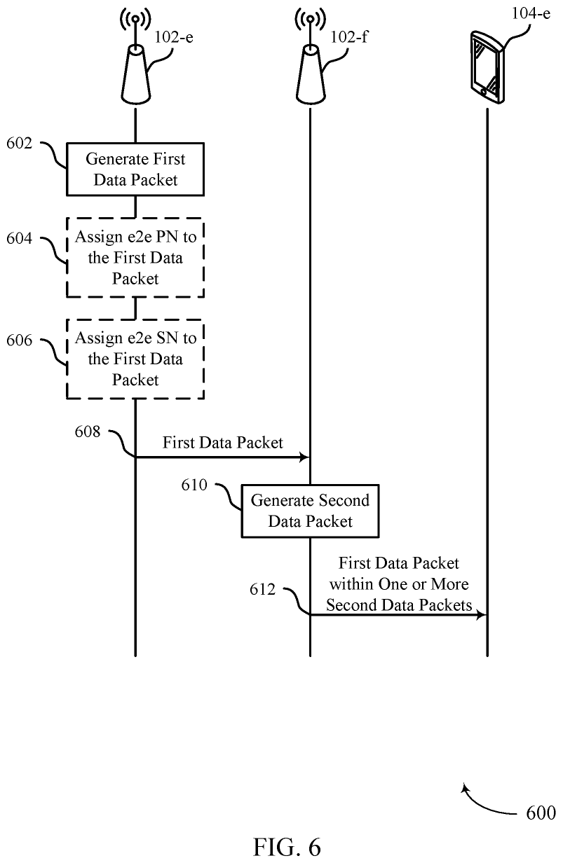

FIG. 6 shows an example of a process flow 600 that supports end-to-end encrypted transmissions in a wireless mesh network. In some examples, the process flow 600 may implement or be implemented by the wireless communication network 100, the wireless mesh network 400, or a combination thereof. For example, the process flow 600 may include an AP 102-c, an AP 102-f, and a STA 104-e which may examples of devices described herein with reference to FIG. 1. In the following description of the process flow 600, the operations between the AP 102-e, the AP 102-f, and the STA 104-c may be performed in different orders or at different times. Some operations also may be left out of the process flow 600, or other operations may be added. Although the AP 102-c, the AP 102-f, and the STA 104-e are shown performing the operations of the process flow 600, some aspects of some operations also may be performed by one or more other wireless devices.

At 602, the AP 102-e may generate a first data packet for the STA 104-c. In some implementations, the AP 102-e may be designated as a central AP 102 for the STA 104-e within a wireless mesh network. In some examples, the AP 102-e also may generate a third data packet for a second STA 104 at the AP 102-e, the one or more second data packets including at least one A-MPDU including both the first data packet and the third data packet. In some other examples, an IP header portion of the first data packet may be end-to-end encrypted based on the first data packet being end-to-end encrypted at the MAC-SAP of the AP 102-c. In some implementations, at 604, the AP 102-e may assign the first data packet an end-to-end packet number, where the first data packet that is encapsulated within the one or more second data packets may include the end-to-end packet number. Additionally, or alternatively, at 606, the AP 102-e may assign a MSDU associated with the first data packet an end-to-end SN, where the MSDU associated with the first data packet that is encapsulated within the one or more second data packets may include the end-to-end sequence number.

At 608, the AP 102-e may transmit, via the AP 102-f, the first data packet to the STA 104-c via two or more links associated with one or more APs 102 (such as the AP 102-f) of the wireless mesh network such that the first data packet is end-to-end encrypted between the AP 102-e and the STA 104-c and the first data packet is encapsulated within one or more second data packets associated with individual links of the wireless mesh network. In some implementations, at 608, the one or more second data packets associated with the individual links of the wireless mesh network may include a header that includes decryption information associated with the first data packet. In some other implementations, the AP 102-e transmitting the first data packet to the STA 104-c may include a MSDU associated with the first data packet being end-to-end encrypted between the AP 102-e and the STA 104-c at a MAC-SAP of the AP 102-c. Further, at 610, upon receiving the first data packet, the AP 102-f may generate a second data packet by encapsulating the first data packet within a data portion of the second packets associated with the individual links of the wireless mesh network. Thus, at 612, the AP 102-f may transmit, to the STA 104-e, the first data packet via one or more second data packets that include an encapsulated first data packet.

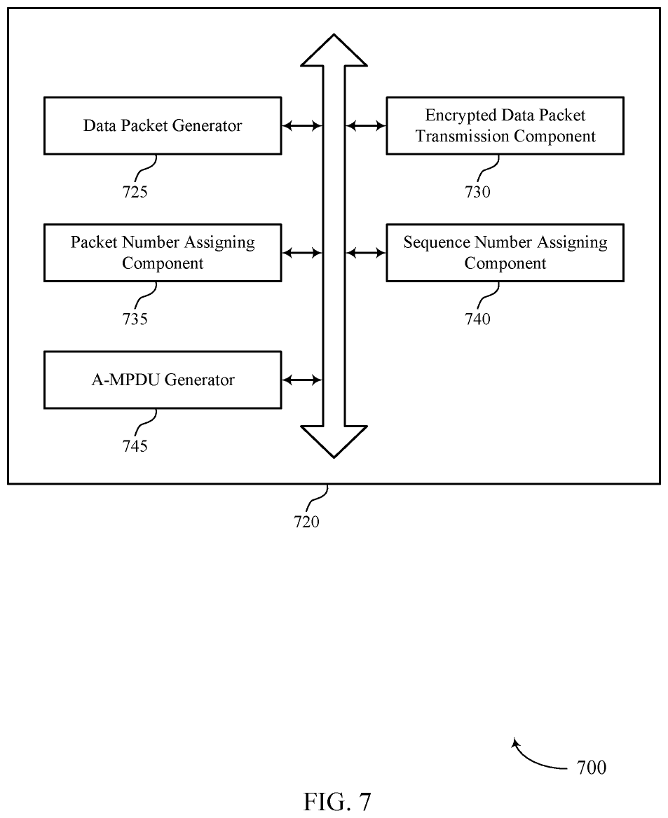

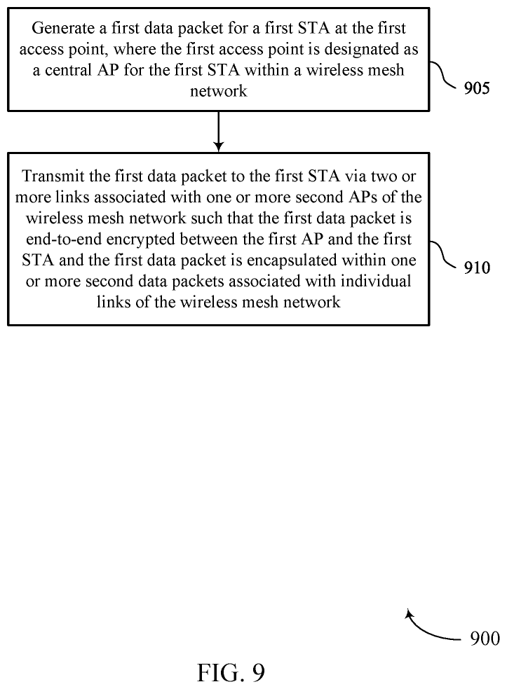

FIG. 7 shows a block diagram of an example wireless communication device 700 that supports end-to-end encrypted transmissions in a wireless mesh network. In some examples, the wireless communication device 700 is configured to perform the process 900 described with reference to FIG. 9. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a data packet generator 725, an encrypted data packet transmission component 730, a packet number assigning component 735, a sequence number assigning component 740, and an A-MPDU generator 745. Portions of one or more of the data packet generator 725, the encrypted data packet transmission component 730, the packet number assigning component 735, the sequence number assigning component 740, and the A-MPDU generator 745 may be implemented at least in part in hardware or firmware. For example, one or more of the data packet generator 725, the encrypted data packet transmission component 730, the packet number assigning component 735, the sequence number assigning component 740, and the A-MPDU generator 745 may be implemented at least in part by at least a processor or a modem. In some examples, portions of one or more of the data packet generator 725, the encrypted data packet transmission component 730, the packet number assigning component 735, the sequence number assigning component 740, and the A-MPDU generator 745 may be implemented at least in part by a processor and software in the form of processor-executable code stored in memory.

The wireless communication device 700 may support wireless communications in accordance with examples as disclosed herein. The data packet generator 725 is configurable or configured to generate a first data packet for a first STA at the first access point, where the first access point is designated as a central AP for the first STA within a wireless mesh network. The encrypted data packet transmission component 730 is configurable or configured to transmit the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

In some examples, the packet number assigning component 735 is configurable or configured to assign the first data packet an end-to-end packet number, where the first data packet that is encapsulated within the one or more second data packets includes the end-to-end packet number.

In some examples, the sequence number assigning component 740 is configurable or configured to assign a medium access control (MAC) service data unit (MSDU) associated with the first data packet an end-to-end sequence number, where the MSDU associated with the first data packet that is encapsulated within the one or more second data packets includes the end-to-end sequence number.

In some examples, the A-MPDU generator 745 is configurable or configured to generate a third data packet for a second STA at the first access point, the one or more second data packets including at least one aggregated medium access control (MAC) protocol data unit (A-MPDU) including both the first data packet and the third data packet.

In some examples, the one or more second data packets associated with the individual links of the wireless mesh network include a header that includes decryption information associated with the first data packet.

In some examples, transmitting the first data packet to the first STA includes a medium access control (MAC) service data unit (MSDU) associated with the first data packet being end-to-end encrypted between the first AP and the first STA at a MAC service AP (MAC-SAP) of the first AP.

In some examples, an internet protocol header portion of the first data packet is end-to-end encrypted based on the first data packet being end-to-end encrypted at the MAC-SAP of the first AP.

In some examples, the first data packet is encapsulated within a data portion of the one or more second packets associated with the individual links of the wireless mesh network.

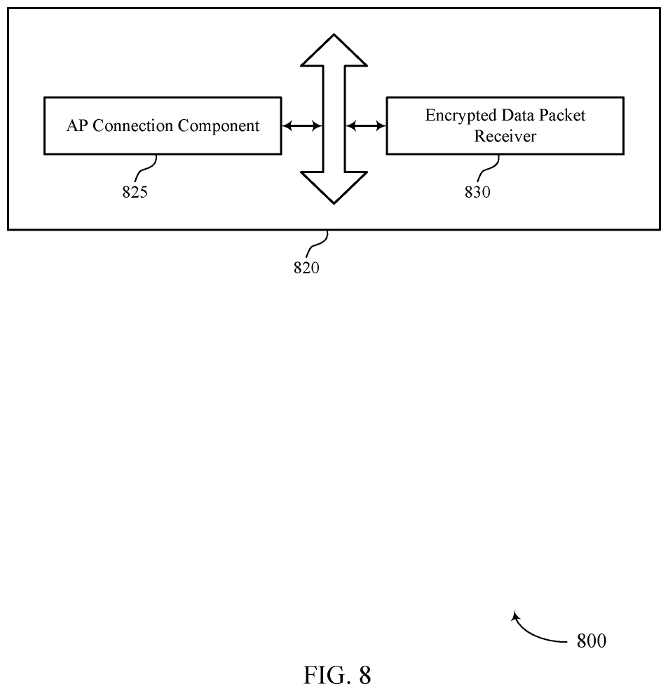

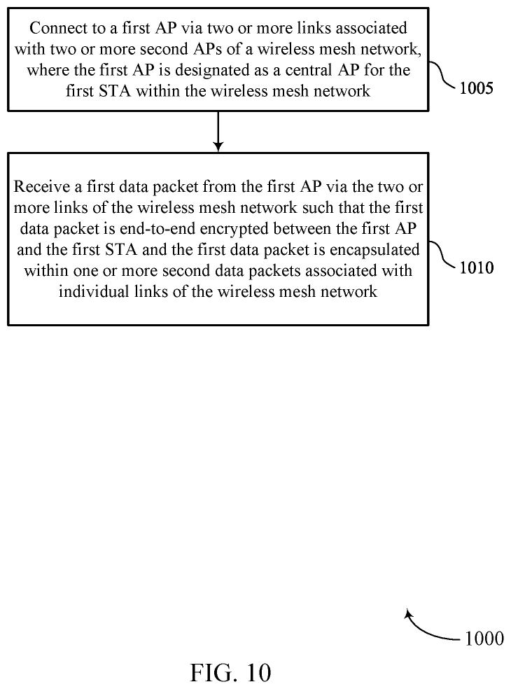

FIG. 8 shows a block diagram of an example wireless communication device 800 that supports end-to-end encrypted transmissions in a wireless mesh network. In some examples, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes a user interface (UI) (such as a touchscreen or keypad) and a display, which may be integrated with the UI to form a touchscreen display that is coupled with the processing system. In some examples, the wireless communication device 800 may further include one or more sensors such as, for example, one or more inertial sensors, accelerometers, temperature sensors, pressure sensors, or altitude sensors, that are coupled with the processing system.

The wireless communication device 800 includes an AP connection component 825 and an encrypted data packet receiver 830. Portions of one or more of the AP connection component 825 and the encrypted data packet receiver 830 may be implemented at least in part in hardware or firmware. For example, one or more of the AP connection component 825 and the encrypted data packet receiver 830 may be implemented at least in part by at least a processor or a modem. In some examples, portions of one or more of the AP connection component 825 and the encrypted data packet receiver 830 may be implemented at least in part by a processor and software in the form of processor-executable code stored in memory.

The wireless communication device 800 may support wireless communications in accordance with examples as disclosed herein. The AP connection component 825 is configurable or configured to connect to a first AP via two or more links associated with two or more second APs of a wireless mesh network, where the first AP is designated as a central AP for the first STA within the wireless mesh network. The encrypted data packet receiver 830 is configurable or configured to receive a first data packet from the first AP via the two or more links of the wireless mesh network such that the first data packet is end-to-end encrypted between the first AP and the first STA and the first data packet is encapsulated within one or more second data packets associated with individual links of the wireless mesh network.

In some examples, the one or more second data packets associated with the individual links of the wireless mesh network include a header that includes decryption information associated with the first data packet.

In some examples, receiving the first data packet from the first AP includes a medium access control (MAC) service data unit (MSDU) associated with the first data packet being end-to-end encrypted between the first AP and the first STA at a MAC service AP (MAC-SAP) of the first AP.

In some examples, an internet protocol header portion of the first data packet is end-to-end encrypted based on the first data packet being end-to-end encrypted at the MAC-SAP of the first AP.

In some examples, the MSDU associated with the first data packet is assigned an end-to-end packet number, an end-to-end sequence number, or both.

In some examples, the first data packet is encapsulated within a data portion of the one or more second packets associated with the individual links of the wireless mesh network.

FIG. 9 shows a flowchart illustrating an example process 900 performable by or at a first AP that supports end-to-end encrypted transmissions in a wireless mesh network. The operations of the process 900 may be implemented by a first AP or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the first AP may generate a first data packet for a first STA at the first access point, where the first access point is designated as a central AP for the first STA within a wireless mesh network. The operations of 905 may be performed in accordance with examples as disclosed herein, e.g., at 602 of FIG. 6. In some implementations, aspects of the operations of 905 may be performed by a data packet generator 725 as described with reference to FIG. 7.

In some examples, in 910, the first AP may transmit the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network. The operations of 910 may be performed in accordance with examples as disclosed herein, e.g., at 608 and 612 of FIG. 6. In some implementations, aspects of the operations of 910 may be performed by an encrypted data packet transmission component 730 as described with reference to FIG. 7.

FIG. 10 shows a flowchart illustrating an example process 1000 performable by or at a first STA that supports end-to-end encrypted transmissions in a wireless mesh network. The operations of the process 1000 may be implemented by a first STA or its components as described herein. For example, the process 1000 may be performed by a wireless communication device, such as the wireless communication device 800 described with reference to FIG. 8, operating as or within a wireless STA. In some examples, the process 1000 may be performed by a wireless STA, such as one of the STAs 104 described with reference to FIG. 1.

In some examples, in 1005, the first STA may connect to a first AP via two or more links associated with two or more second APs of a wireless mesh network, where the first AP is designated as a central AP for the first STA within the wireless mesh network. The operations of 1005 may be performed in accordance with examples as disclosed herein, e.g., as shown in FIG. 4. In some implementations, aspects of the operations of 1005 may be performed by an AP connection component 825 as described with reference to FIG. 8.

In some examples, in 1010, the first STA may receive a first data packet from the first AP via the two or more links of the wireless mesh network such that the first data packet is end-to-end encrypted between the first AP and the first STA and the first data packet is encapsulated within one or more second data packets associated with individual links of the wireless mesh network. The operations of 1010 may be performed in accordance with examples as disclosed herein, e.g., at 612 of FIG. 6. In some implementations, aspects of the operations of 1010 may be performed by an encrypted data packet receiver 830 as described with reference to FIG. 8.

Implementation examples are described in the following numbered clauses:

Aspect 1: A method for wireless communications by a first AP, including: generating a first data packet for a first STA at the first access point, where the first access point is designated as a central AP for the first STA within a wireless mesh network; and transmitting the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

Aspect 2: The method of aspect 1, further including: assigning the first data packet an end-to-end packet number, where the first data packet that is encapsulated within the one or more second data packets includes the end-to-end packet number.

Aspect 3: The method of any of aspects 1-2, further including: assigning a medium access control (MAC) service data unit (MSDU) associated with the first data packet an end-to-end sequence number, where the MSDU associated with the first data packet that is encapsulated within the one or more second data packets includes the end-to-end sequence number.

Aspect 4: The method of any of aspects 1-3, further including: generating a third data packet for a second STA at the first access point, the one or more second data packets including at least one aggregated MAC protocol data unit (A-MPDU) including both the first data packet and the third data packet.

Aspect 5: The method of any of aspects 1-4, where the one or more second data packets associated with the individual links of the wireless mesh network comprise a header that includes decryption information associated with the first data packet.

Aspect 6: The method of any of aspects 1-5, where transmitting the first data packet to the first STA includes a MSDU associated with the first data packet being end-to-end encrypted between the first AP and the first STA at a MAC service AP (MAC-SAP) of the first AP.

Aspect 7: The method of aspect 6, where an internet protocol header portion of the first data packet is end-to-end encrypted based at least in part on the first data packet being end-to-end encrypted at the MAC-SAP of the first AP.

Aspect 8: The method of any of aspects 1-7, where the first data packet is encapsulated within a data portion of the one or more second packets associated with the individual links of the wireless mesh network.

Aspect 9: A method for wireless communications by a first STA, including: connecting to a first AP via two or more links associated with two or more second APs of a wireless mesh network, where the first AP is designated as a central AP for the first STA within the wireless mesh network; and receiving a first data packet from the first AP via the two or more links of the wireless mesh network such that the first data packet is end-to-end encrypted between the first AP and the first STA and the first data packet is encapsulated within one or more second data packets associated with individual links of the wireless mesh network.

Aspect 10: The method of aspect 9, where the one or more second data packets associated with the individual links of the wireless mesh network comprise a header that includes decryption information associated with the first data packet.

Aspect 11: The method of any of aspects 9-10, where receiving the first data packet from the first AP includes a MSDU associated with the first data packet being end-to-end encrypted between the first AP and the first STA at a MAC-SAP of the first AP.

Aspect 12: The method of aspect 11, where an internet protocol header portion of the first data packet is end-to-end encrypted based at least in part on the first data packet being end-to-end encrypted at the MAC-SAP of the first AP.

Aspect 13: The method of any of aspects 11-12, where the MSDU associated with the first data packet is assigned an end-to-end packet number, an end-to-end sequence number, or both.

Aspect 14: The method of any of aspects 9-13, where the first data packet is encapsulated within a data portion of the one or more second packets associated with the individual links of the wireless mesh network.

Aspect 15: A first AP for wireless communications, including one or more memories storing processor-executable code, and one or more processors coupled with the one or more memories and individually or collectively operable to execute the code to cause the first AP to perform a method of any of aspects 1-8.

Aspect 16: A first AP for wireless communications, including at least one means for performing a method of any of aspects 1-8.

Aspect 17: A non-transitory computer-readable medium storing code for wireless communications, the code including instructions executable by one or more processors to perform a method of any of aspects 1-8.

Aspect 18: A first STA for wireless communications, including one or more memories storing processor-executable code, and one or more processors coupled with the one or more memories and individually or collectively operable to execute the code to cause the first STA to perform a method of any of aspects 9-14.

Aspect 19: A first STA for wireless communications, including at least one means for performing a method of any of aspects 9-14.

Aspect 20: A non-transitory computer-readable medium storing code for wireless communications, the code including instructions executable by one or more processors to perform a method of any of aspects 9-14.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
generate a first data packet for a first station (STA) at the first access point, wherein the first AP is designated as a central AP for the first STA within a wireless mesh network; and
transmit the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

2. The first AP of claim 1, wherein the processing system is further configured to cause the first AP to:
assign the first data packet an end-to-end packet number, wherein the first data packet that is encapsulated within the one or more second data packets includes the end-to-end packet number.

3. The first AP of claim 1, wherein the processing system is further configured to cause the first AP to:
assign a medium access control (MAC) service data unit (MSDU) associated with the first data packet an end-to-end sequence number, wherein the MSDU associated with the first data packet that is encapsulated within the one or more second data packets includes the end-to-end sequence number.

4. The first AP of claim 1, wherein the processing system is further configured to cause the first AP to:
generate a third data packet for a second STA at the first access point, the one or more second data packets including at least one aggregated medium access control (MAC) protocol data unit (A-MPDU) including both the first data packet and the third data packet.

5. The first AP of claim 1, wherein the one or more second data packets associated with the individual links of the wireless mesh network comprise a header that includes decryption information associated with the first data packet.

6. The first AP of claim 1, wherein transmitting the first data packet to the first STA includes a medium access control (MAC) service data unit (MSDU) associated with the first data packet being end-to-end encrypted between the first AP and the first STA at a MAC service AP (MAC-SAP) of the first AP.

7. The first AP of claim 6, wherein an internet protocol header portion of the first data packet is end-to-end encrypted based at least in part on the first data packet being end-to-end encrypted at the MAC-SAP of the first AP.

8. The first AP of claim 1, wherein the first data packet is encapsulated within a data portion of the one or more second packets associated with the individual links of the wireless mesh network.

9. The first AP of claim 1, wherein the first AP is connected to a wireless area network (WAN) based at least in part on being the central AP within the wireless mesh network.

10. A first station (STA), comprising:
a processing system that includes processor circuitry and memory circuitry that stores code, the processing system configured to cause the first STA to:
connect to a first access point (AP) via two or more links associated with two or more second APs of a wireless mesh network, wherein the first AP is designated as a central AP for the first STA within the wireless mesh network; and
receive a first data packet from the first AP via the two or more links of the wireless mesh network such that the first data packet is end-to-end encrypted between the first AP and the first STA and the first data packet is encapsulated within one or more second data packets associated with individual links of the wireless mesh network.

11. The first STA of claim 10, wherein the one or more second data packets associated with the individual links of the wireless mesh network comprise a header that includes decryption information associated with the first data packet.

12. The first STA of claim 10, wherein receiving the first data packet from the first AP includes a medium access control (MAC) service data unit (MSDU) associated with the first data packet being end-to-end encrypted between the first AP and the first STA at a MAC service AP (MAC-SAP) of the first AP.

13. The first STA of claim 12, wherein an internet protocol header portion of the first data packet is end-to-end encrypted based at least in part on the first data packet being end-to-end encrypted at the MAC-SAP of the first AP.

14. The first STA of claim 12, wherein the MSDU associated with the first data packet is assigned an end-to-end packet number, an end-to-end sequence number, or both.

15. The first STA of claim 10, wherein the first data packet is encapsulated within a data portion of the one or more second packets associated with the individual links of the wireless mesh network.

16. A method for wireless communications by a first access point (AP), comprising:
generating a first data packet for a first station (STA) at the first access point, wherein the first access point is designated as a central AP for the first STA within a wireless mesh network; and
transmitting the first data packet to the first STA via two or more links associated with one or more second APs of the wireless mesh network such that the first data packet is end-to-end encrypted between the first AP and the first STA and the first data packet is encapsulated within one or more second data packets associated with individual links of the wireless mesh network.

17. The method of claim 16, further comprising:
assigning the first data packet an end-to-end packet number, wherein the first data packet that is encapsulated within the one or more second data packets includes the end-to-end packet number.

18. The method of claim 16, further comprising:
assigning a medium access control (MAC) service data unit (MSDU) associated with the first data packet an end-to-end sequence number, wherein the MSDU associated with the first data packet that is encapsulated within the one or more second data packets includes the end-to-end sequence number.

19. The method of claim 16, further comprising:
generating a third data packet for a second STA at the first access point, the one or more second data packets including at least one aggregated medium access control (MAC) protocol data unit (A-MPDU) including both the first data packet and the third data packet.

20. The method of claim 16, wherein the one or more second data packets associated with the individual links of the wireless mesh network comprise a header that includes decryption information associated with the first data packet.

21. The method of claim 16, wherein transmitting the first data packet to the first STA includes a medium access control (MAC) service data unit (MSDU) associated with the first data packet being end-to-end encrypted between the first AP and the first STA at a MAC service AP (MAC-SAP) of the first AP.

22. The method of claim 21, wherein an internet protocol header portion of the first data packet is end-to-end encrypted based at least in part on the first data packet being end-to-end encrypted at the MAC-SAP of the first AP.

23. The method of claim 16, wherein the first data packet is encapsulated within a data portion of the one or more second packets associated with the individual links of the wireless mesh network.

24. The method of claim 16, wherein the first AP is connected to a wireless area network (WAN) based at least in part on being the central AP within the wireless mesh network.

25. A method for wireless communications by a first station (STA), comprising:
connecting to a first access point (AP) via two or more links associated with two or more second APs of a wireless mesh network, wherein the first AP is designated as a central AP for the first STA within the wireless mesh network; and
receiving a first data packet from the first AP via the two or more links of the wireless mesh network such that the first data packet is end-to-end encrypted between the first AP and the first STA and the first data packet is encapsulated within one or more second data packets associated with individual links of the wireless mesh network.

26. The method of claim 25, wherein the one or more second data packets associated with the individual links of the wireless mesh network comprise a header that includes decryption information associated with the first data packet.

27. The method of claim 25, wherein receiving the first data packet from the first AP includes a medium access control (MAC) service data unit (MSDU) associated with the first data packet being end-to-end encrypted between the first AP and the first STA at a MAC service AP (MAC-SAP) of the first AP.

28. The method of claim 27, wherein an internet protocol header portion of the first data packet is end-to-end encrypted based at least in part on the first data packet being end-to-end encrypted at the MAC-SAP of the first AP.

29. The method of claim 27, wherein the MSDU associated with the first data packet is assigned an end-to-end packet number, an end-to-end sequence number, or both.

30. The method of claim 25, wherein the first data packet is encapsulated within a data portion of the one or more second packets associated with the individual links of the wireless mesh network.
